(19) United States
(12) Patent Application Publication
(10) Pub. No.: US 2026/0299821 A1
(43) Pub. Date: Oct. 1, 2026

(54) DDR-SDRAM CONTROL SYSTEM

(71) Applicant: AISIN CORPORATION, Kariya (JP)

(72) Inventor: Takanobu NARUSE, Kariya-shi (JP)

(73) Assignee: AISIN CORPORATION, Kariya (JP)

(21) Appl. No.: 19/567,544

(22) Filed: Mar. 16, 2026

(30) Foreign Application Priority Data
Mar. 28, 2025 (JP) 2025-055767

(51) Int. Cl. G06F 3/06

(52) U.S. Cl. CPC G06F 3/0655; G06F 3/0604; G06F 3/0673

(57) ABSTRACT

A DDR-SDRAM control system, including:
a DDR memory having a plurality of memory cells for storing data; and
a memory controller that controls write, read, and refresh in units of banks for the plurality of memory cells, the memory controller including:
a refresh range setting register that stores setting information of a refresh enabled range that is a range in which refresh is performed and of a refresh disabled range that is a range in which refresh is not performed, the refresh enabled range and the refresh disabled range being among the plurality of banks,
wherein, when refresh of the DDR memory is performed, the DDR-SDRAM control system refers to the refresh range setting register and performs refresh on the bank in the refresh enabled range.

### CROSS REFERENCE TO RELATED APPLICATIONS

This application is based on and claims priority under 35 U.S.C. § 119 to Japanese Patent Application No. 2025-055767, filed on Mar. 28, 2025, the entire content of which is incorporated herein by reference.

### TECHNICAL FIELD

An embodiment of the present disclosure relates to a DDR-SDRAM control system.

### BACKGROUND DISCUSSION

A double data rate-synchronous dynamic random access memory (DDR-SDRAM) is a semiconductor memory widely used as a main storage device (main memory) of a computer in recent years, and is a device whose data transfer speed is greatly improved by improving a conventional synchronous dynamic random access memory (SDRAM). (See JP 2007-503069 A)

In addition, in recent years, a capacity of the DDR-SDRAM serving as a main memory has increased with diversification and multi-functionality of various electronic devices. Therefore, even in a system that uses only a small amount of data, an excessively large DDR-SDRAM may be used.

Regarding refresh (rewrite operation) of a DDR memory (a memory in the DDR-SDRAM), as for self-refresh, a per BANK self-refresh function is provided in the DDR memory. However, such a function is not provided on the memory controller side, and the entire DDR memory is required to be refreshed. Therefore, there is a problem that power consumption increases due to refresh of most of the region that does not need to be refreshed.

A need thus exists for a DDR-SDRAM control system which is not susceptible to the drawback mentioned above.

### SUMMARY

A DDR-SDRAM control system of the embodiment includes: a DDR memory having a plurality of memory cells for storing data; and a memory controller that controls write, read, and refresh in units of banks for the plurality of memory cells, the memory controller including: a refresh range setting register that stores setting information of a refresh enabled range that is a range in which refresh is performed and of a refresh disabled range that is a range in which refresh is not performed, the refresh enabled range and the refresh disabled range being among the plurality of banks. When refresh of the DDR memory is performed, the DDR-SDRAM control system refers to the refresh range setting register and performs refresh on the bank in the refresh enabled range.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a functional configuration diagram of an ECU according to an embodiment;

FIG. 2 is an explanatory diagram of a refresh method of a DDR memory in a prior art;

FIG. 3 is an explanatory diagram of a first refresh method of the DDR memory in the embodiment;

FIG. 4 is a flowchart illustrating processing when a memory controller performs a first refresh method;

FIG. 5 is an explanatory diagram of a second refresh method of the DDR memory in the embodiment; and

FIG. 6 is a flowchart illustrating processing when the memory controller performs a second refresh method.

### DETAILED DESCRIPTION

Hereinafter, an exemplary embodiment of the present disclosure will be disclosed. The configurations of the embodiment described below and, in addition, the actions, results, and effects provided by the configuration are examples. The present disclosure can be realized by a configuration other than those disclosed in the following embodiment, and it is possible to obtain at least one of various effects based on the basic configuration and derivative effects thereof. In the following embodiment, a description will be given taking as an example a case where the DDR-SDRAM of the present disclosure is applied to an electronic control unit (ECU) used in a vehicle (such as an automobile).

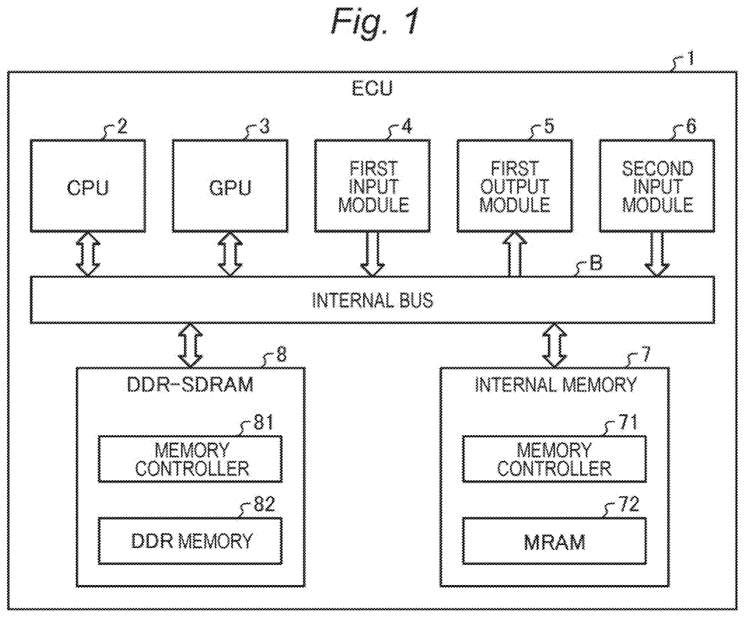

FIG. 1 is a functional configuration diagram of an ECU 1 according to the embodiment. In the ECU 1, there are disposed a central processing unit (CPU) 2, a graphics processing unit (GPU) 3, a first input module 4, a first output module 5, a second input module 6, an internal memory 7, and a double data rate synchronous dynamic random access memory (DDR-SDRAM) 8 (DDR-SDRAM control system) so as to be communicable with each other via an internal bus B. Note that this drawing is illustrated in a simplified manner, and actually, for example, a direct memory access (DMA) controller, a cache memory, or the like may be provided as another configuration.

The CPU 2 performs various types of arithmetic processing. For example, the CPU 2 transmits an instruction signal to the first input module 4 or the second input module 6 to store data that is input, in the internal memory 7 or the DDR-SDRAM 8.

A GPU 3 mainly performs image processing.

The first input module 4 transmits input predetermined data to the internal memory 7 or the DDR-SDRAM 8 via the internal bus B. The first input module 4 is, for example, an image input module.

The first output module 5 outputs predetermined data received from the internal memory 7 or the DDR-SDRAM 8 via the internal bus B. The first output module 5 is, for example, a display output module. In this case, for example, the GPU 3 transmits an instruction signal to the first output module 5 to display the information received from the internal memory 7 or the DDR-SDRAM 8 on a display device (not illustrated).

Similarly to the first input module 4, the second input module 6 transmits input predetermined data to the internal memory 7 or the DDR-SDRAM 8 via the internal bus B.

The internal memory 7 is a storage device, and includes a memory controller 71 and an MRAM 72 (STT-MRAM).

The MRAM 72 has a plurality of memory regions for storing data.

The memory controller 71 controls write, read, refresh, and the like for each of the plurality of memory regions of the MRAM 72.

The DDR-SDRAM 8 includes a memory controller 81 and a DDR memory 82. In the present embodiment, the DDR-SDRAM refers to the following.

(1) Low-power (LP) DDR4-SDRAM, LPDDR4x-SDRAM, LPDDR5-SDRAM, LPDDR5x-SDRAM, and the like (which are applied to, for example, a smartphone and a vehicle), (2) graphics (G) DDR5-SDRAM, GDDR5x-SDRAM, GDDR6-SDRAM, GDDR7-SDRAM, and the like (which are applied to, for example, a graphic board), and (3) DDR4-SDRAM, DDR5-SDRAM, DDR6-SDRAM, and the like (which are applied to, for example, a personal computer).

The DDR memory 82 has a plurality of memory cells for storing data.

The memory controller 81 controls write, read, and refresh in units of banks for a plurality of memory cells of the DDR memory 82.

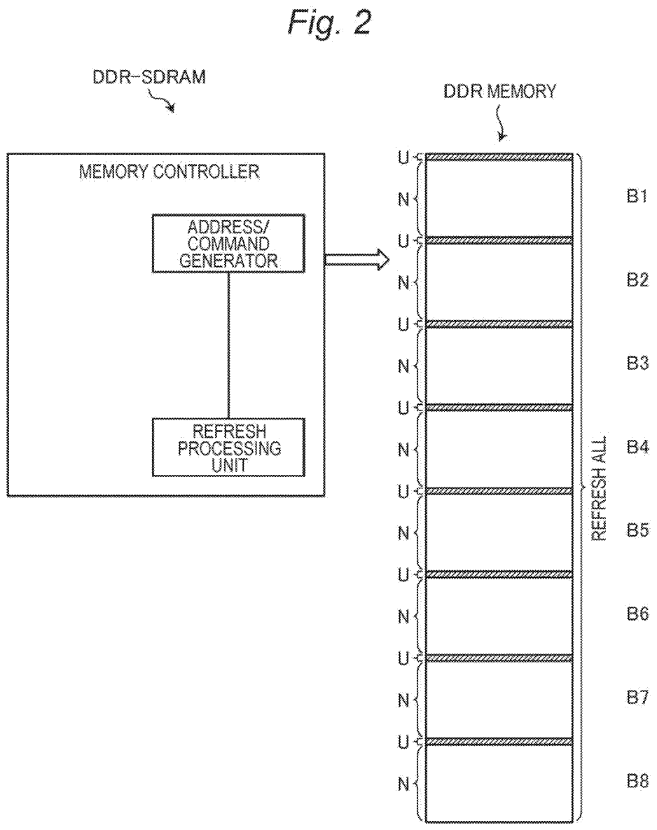

Here, to help understanding, a prior art will be described with reference to FIG. 2. FIG. 2 is an explanatory diagram of a refresh method of a DDR memory in the prior art. In the DDR-SDRAM of the prior art, a memory controller includes an address/command generator and a refresh processing unit.

The address/command generator generates an access destination address, a command, and the like when the memory controller writes, reads, or refreshes the DDR memory.

The refresh processing unit performs refresh by using an access destination address, a command, or the like generated by the address/command generator.

In the example of FIG. 2, banks B1 to B8 are illustrated in the DDR memory. In addition, regions U are used regions, and regions N are non-used regions.

In the prior art, as described above, the entire DDR memory has to be refreshed. Therefore, there is a problem that power consumption increases due to refresh of most of the region that does not need to be refreshed.

Therefore, in the following, a first refresh method and a second refresh method will be described for a technique of reducing power consumption due to refresh of the DDR memory.

### First Refresh Method

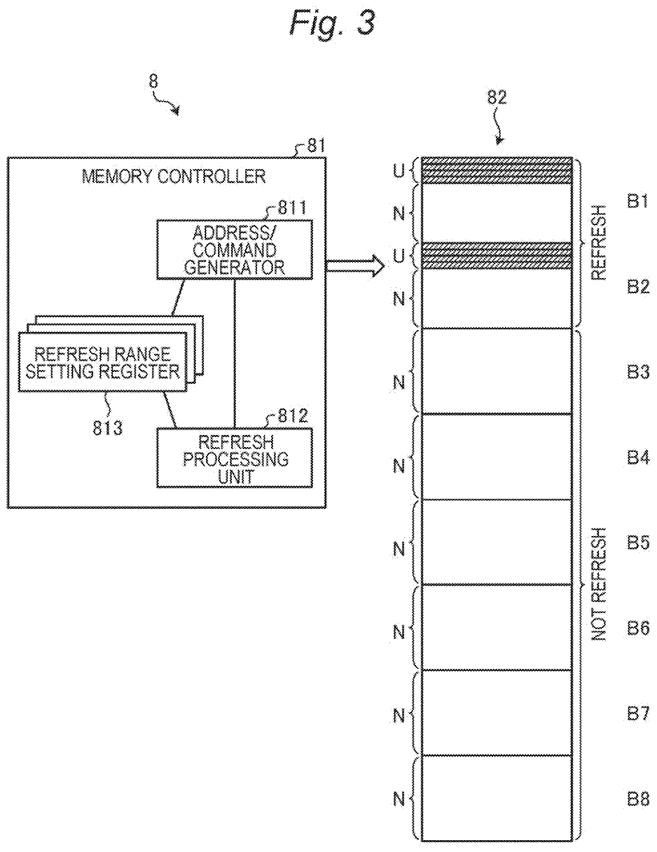

FIG. 3 is an explanatory diagram of the first refresh method of the DDR memory 82 in the embodiment. A memory controller 81 includes an address/command generator 811, a refresh processing unit 812, and a plurality of refresh range setting registers 813.

The address/command generator 811 generates an access destination address, a command, and the like when write, read, or refresh is performed on the DDR memory 82.

The refresh processing unit 812 performs refresh of the DDR memory 82 by using the access destination address, the command, or the like generated by the address/command generator 811.

In the example of FIG. 3, banks B1 to B8 are illustrated in the DDR memory 82. In addition, regions U are used regions, and regions N are non-used regions.

The refresh range setting registers 813 store setting information of the following ranges among the plurality of banks: the refresh enabled range (the banks B1 and B2 of FIG. 3) that is a range in which refresh is performed; and the refresh disabled range (hereinafter, it may be simply referred to as a “disabled range”) (the banks B3 to B8 in FIG. 3) that is a range in which refresh is not performed. Then, when refresh is performed, the refresh processing unit 812 refers to the refresh range setting registers 813 and performs refresh on the banks in the refresh enabled range (the banks B1 and B2 in FIG. 3).

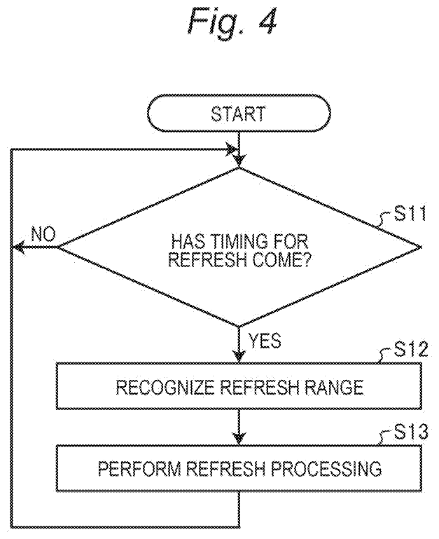

FIG. 4 is a flowchart illustrating processing when the memory controller 81 performs the first refresh method. Note that a description of processing of the address/command generator 811 is omitted.

In step S11, the refresh processing unit 812 determines whether a timing for refresh has come. If Yes, the process proceeds to step S12. If No, the process returns to step S11.

In step S12, the refresh processing unit 812 refers to the refresh range setting registers 813 to recognize the refresh range (refresh enabled range).

Next, in step S13, the refresh processing unit 812 performs refresh processing on the refresh range recognized in step S12.

### Second Refresh Method

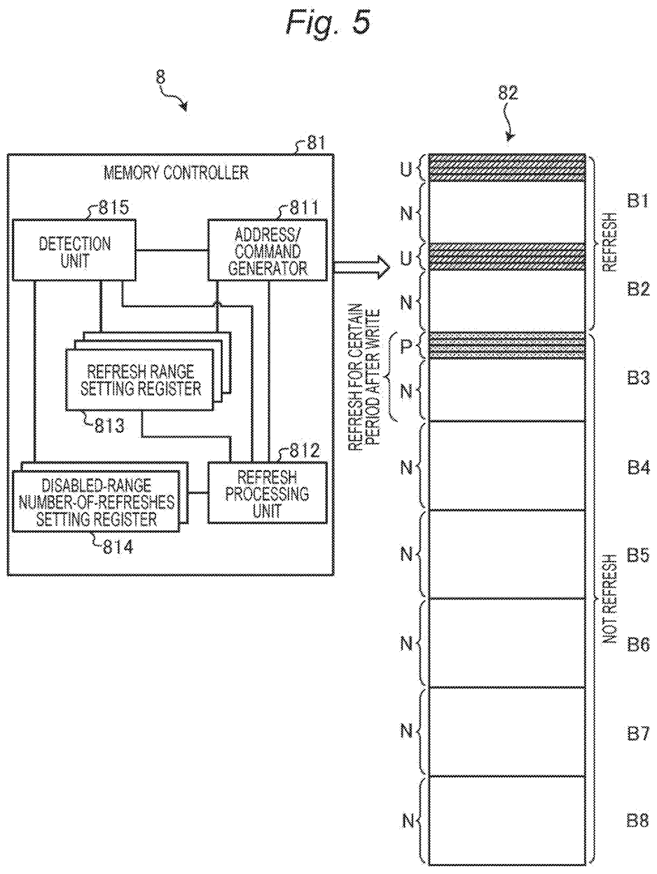

FIG. 5 is an explanatory diagram of the second refresh method of the DDR memory according to the embodiment. A description of matters similar to those in the first refresh method will be omitted as appropriate. A region P is a region where data (for example, over the air (OTA) update data, or the like) is newly written.

The memory controller 81 further includes a plurality of disabled-range number-of-refreshes setting registers 814 and a detection unit 815.

The disabled-range number-of-refreshes setting registers 814 store setting information (for example, 10 times or the like) of the number of refreshes for the refresh disabled ranges (the banks B3 to B8 in FIG. 5) in the DDR memory 82.

A detection unit 815 detects write to the refresh disabled range of the DDR memory 82.

When the detection unit 815 detects the write to the refresh disabled range of the DDR memory 82, the refresh processing unit 812 refers to the disabled-range number-of-refreshes setting registers 814, and refreshes the refresh disabled range in which the write is detected (the bank B3 in FIG. 5) for the number of refreshes that is set.

In addition, the memory controller 81 (detection unit 815) can register setting information of the number of refreshes for each piece of target data in the disabled-range number-of-refreshes setting registers 814. The number of refreshes is determined according to a required storage time of target data. For example, when the data in the region P is the OTA update data, the data becomes unnecessary when the update is completed; therefore, the number of refreshes may be determined using information of the completion timing of the update.

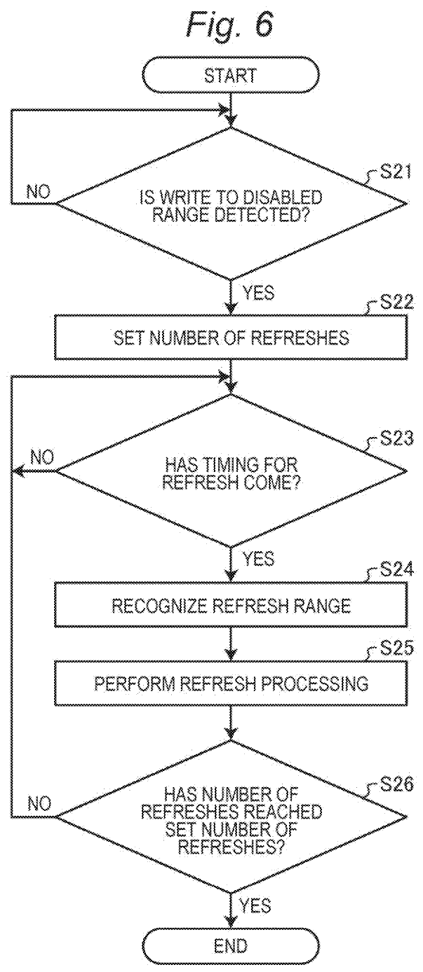

FIG. 6 is a flowchart illustrating processing when the memory controller performs the second refresh method. Note that a description of processing of the address/command generator 811 is omitted.

In step S21, the detection unit 815 determines whether write to the refresh disabled range is detected. If Yes, the process proceeds to step S22. If No, the process returns to step S21.

In step S22, the detection unit 815 registers the setting information of the number of refreshes of the data detected in step S21, in the disabled-range number-of-refreshes setting registers 814.

Next, in step S23, the refresh processing unit 812 determines whether it is a timing for refresh. If Yes, the process proceeds to step S24. If No, the process returns to step S23.

In step S24, the refresh processing unit 812 refers to the refresh range setting registers 813 to recognize the refresh range (refresh enabled range).

Next, in step S25, the refresh processing unit 812 performs refresh processing on the refresh range recognized in step S24.

Next, in step S26, the refresh processing unit 812 determines whether the number of refreshes (the number of refreshes performed) has reached a set number of refreshes (the number of refreshes set in the disabled-range number-of-refreshes setting registers 814). If Yes, the process is ended, and if No, the process returns to step S23.

As described above, with the DDR-SDRAM 8 of the present embodiment, when the memory controller 81 performs refresh of the DDR memory 82, the memory controller 81 refers to the refresh range setting registers 813 and refreshes the bank in the refresh enabled range; thus, it is possible to selectively refresh a part of the DDR memory 82 that needs to be refreshed. Therefore, it is possible to reduce power consumption due to refresh of the DDR memory 82. That is, it is possible to suppress an increase in power consumption for refreshing most of the region that does not need to be refreshed. Furthermore, necessary data can be held.

As illustrated in FIGS. 5 and 6, when the detection unit 815 detects the write to the refresh disabled range of the DDR memory 82, the refresh processing unit 812 refers to the disabled-range number-of-refreshes setting registers 814, and refreshes the refresh disabled range in which the write is detected, for the number of refreshes that is set. As a result, for the data in the refresh disabled range, refresh can be performed for an appropriate set number of refreshes according to the required storage time, and power consumption due to refresh can be reduced.

In addition, setting information of the number of refreshes for each piece of target data is registered in the disabled-range number-of-refreshes setting registers 814. As a result, an appropriate number of refreshes can be set for each piece of target data.

Note that the program executed by the ECU 1 may be stored as a file in an installable format or an executable format in a computer-readable storage medium such as a CD-ROM, a CD-R, a memory card, a digital versatile disk (DVD), or a flexible disk (FD) and provided as a computer program product. Furthermore, the program may be provided by being stored on a computer connected to a network such as the Internet and downloaded via the network. Furthermore, the program may be provided or distributed via a network such as the Internet.

The embodiment of the present disclosure has been described above; however, the above embodiment has been presented as an example, and is not intended to limit the scope of the disclosure. The above novel embodiment can be performed in various modes, and various omissions, substitutions, and changes can be made without departing from the gist of the disclosure. The above embodiment and the variations thereof are included in the scope and gist of the present disclosure and are included in the disclosure described in the claims and the equivalent scope thereof.

For example, the application to which the DDR-SDRAM of the present disclosure is applied is not limited to the ECU used in the vehicle of the above-described embodiment, and may be other fields such as a smartphone and a personal computer.

### Summary of Embodiments

The present embodiment includes at least the following configuration.

A DDR-SDRAM control system of the embodiment includes: a DDR memory having a plurality of memory cells for storing data; and a memory controller that controls write, read, and refresh in units of banks for the plurality of memory cells, the memory controller including: a refresh range setting register that stores setting information of a refresh enabled range that is a range in which refresh is performed and of a refresh disabled range that is a range in which refresh is not performed, the refresh enabled range and the refresh disabled range being among the plurality of banks. When refresh of the DDR memory is performed, the DDR-SDRAM control system refers to the refresh range setting register and performs refresh on the bank in the refresh enabled range.

With such a configuration, in the DDR-SDRAM control system, power consumption due to refresh of the DDR memory can be reduced.

Furthermore, the memory controller further includes a disabled-range number-of-refreshes setting register that stores setting information of a number of refreshes for the refresh disabled range in the DDR memory, and when write to the refresh disabled range in the DDR memory is detected, the memory controller refers to the disabled-range number-of-refreshes setting register and performs refresh on the refresh disabled range in which the write is detected, for the number of refreshes that is set.

As a result, it is possible to refresh the data in the refresh disabled range for an appropriate set number of refreshes according to a required storage time, and it is possible to reduce power consumption due to refresh.

In addition, the memory controller registers setting information of a number of refreshes for each piece of target data in the disabled-range number-of-refreshes setting registers.

With such a configuration, an appropriate number of refreshes can be set for each piece of target data.

Note that the effects of the dependent claims and the embodiment are additional effects different from the effects of the independent claim.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A DDR-SDRAM control system, comprising:
a DDR memory having a plurality of memory cells for storing data; and
a memory controller that controls write, read, and refresh in units of banks for the plurality of memory cells, the memory controller including:
a refresh range setting register that stores setting information of a refresh enabled range that is a range in which refresh is performed and of a refresh disabled range that is a range in which refresh is not performed, the refresh enabled range and the refresh disabled range being among the plurality of banks,
wherein, when refresh of the DDR memory is performed, the DDR-SDRAM control system refers to the refresh range setting register and performs refresh on the bank in the refresh enabled range.

2. The DDR-SDRAM control system according to claim 1, wherein the memory controller further includes a disabled-range number-of-refreshes setting register that stores setting information of a number of refreshes for the refresh disabled range in the DDR memory, and
when write to the refresh disabled range in the DDR memory is detected, the memory controller refers to the disabled-range number-of-refreshes setting register and performs refresh on the refresh disabled range in which the write is detected, for the number of refreshes that is set.

3. The DDR-SDRAM control system according to claim 2, wherein the memory controller registers, in the disabled-range number-of-refreshes setting register, setting information of a number of refreshes for each piece of target data.
